(19) United States
(12) Patent Application Publication
(10) Pub. No.: US 2022/0205780 A1
(43) Pub. Date: Jun. 30, 2022

(54) DEVICE AND METHOD FOR MEASURING SURFACE ROUGHNESS OF CMP PAD

(71) Applicant: CHUNG ANG University industry Academic Cooperation Foundation, Seoul (KR)

(72) Inventors: Woojune CHOI, Busan (KR); Eunsoo KIM, Daejeon (KR)

(73) Assignee: CHUNG ANG University industry Academic Cooperation Foundation, Seoul (KR)

(21) Appl. No.: 17/462,587

(22) Filed: Aug. 31, 2021

(30) Foreign Application Priority Data
Dec. 29, 2020 (KR) 10-2020-0186387

(51) Int. Cl. G01B 11/30; G06T 7/00

(52) U.S. Cl. CPC G01B 11/303; G06T 2207/10152; G06T 2207/30148; G06T 7/0006

(57) ABSTRACT

A device for measuring surface roughness of a CMP pad includes: a light radiator having a light source; a light flux divider configured to divide and radiate light emitted from the light radiator to a measurement target; an interference image creator configured to generate interference by overlapping reflective light of the measurement target, which is generated when light is radiated to the measurement target through the light flux divider, and the light radiated to the measurement target; an image obtaining-storing unit configured to obtain several interference pattern-modulated images created by the interference image creator; and an image post-processing output unit configured to output a 3D pad surface profile by performing post-processing on the interference pattern-modulated images of the image obtaining-storing unit.

This research was supported in part by the Basic Science Research Program (Grant number 2020R1F1A1072912) and by the Engineering Research Center (Grant number 2020R1A5A1018052) funded by the Ministry of Science and ICT, Republic of Korea.

### CROSS-REFERENCE TO PRIOR APPLICATION

This application claims priority to Korean Patent Application No. 10-2020-0186387 (filed on Dec. 29, 2020), which is hereby incorporated by reference in its entirety.

### BACKGROUND

The present disclosure relates to a device for planarizing a semiconductor, in detail, to a device and method for measuring surface roughness of a CMP (Chemical Mechanical Polishing) pad, the device and method making it possible to efficiently evaluate surface roughness of a polishing pad through non-contact nondestructive optical measurement at a site where CMP that is a necessary process for planarizing silicon wafers is performed.

CMP (Chemical Mechanical Polishing), which is a process of planarizing or removing a surface by polishing an oxide film or a thin metal film applied on a substrate, using chemical and physical actions, is a process that is widely used throughout the material and electronic industries.

It is required for a silicon wafer to have a high-quality surface in order to micronize a semiconductor circuit pattern that is needed to manufacture ULSI (Ultra Large Scale Integration) semiconductor devices. Accordingly, global planarization by CMP that is a wafer surface machining technology in the process of manufacturing wafers is becoming a prior core machining technology for manufacturing ULSI semiconductor devices.

A CMP pad is a main part that determines the flatness of semiconductor wafers, and the final quality of a wafer surface depends on the surface state (roughness, the size of micro holes, etc.) of the pad.

Accordingly, it is very important to sense the wear state of a polishing pad, which depends on an increase of the number of times of processing, at a site so that the polishing pad can be replaced at an appropriate time.

Various electro-optical profile measurement technologies have been proposed to evaluate the surface state of a polishing pad.

However, the technologies of the related art are suitable for examining dried pads and have difficulty in approaching polishing pads immersed in a polishing slurry suspension or wetted with a suspension during CMP, so they substantially cannot perform examination at a site.

Recently, a laser scanning confocal microscope that can diagnose pads at a site has been introduced by Sensorfar.

However, the measurement range is very limited in spite of excellent pad accessibility, so it is difficult to quickly and generally analyze a CMP pad for large-diameter (300 mm) wafers.

Accordingly, it is required to develop a new technology that can efficiently evaluate and analyze surface roughness of a polishing pad at a site where CMP is performed.

### SUMMARY

The present disclosure has been made in an effort to solve the problems of a CMP control technology in the related art and an object of the present disclosure is to provide a device and method for measuring surface roughness of a CMP (Chemical Mechanical Polishing) pad, the device and method making it possible to efficiently evaluate surface roughness of a polishing pad through non-contact nondestructive optical measurement at a site where CMP that is a necessary process for planarizing silicon wafers is performed.

Another object of the present disclosure is to provide a device and method for measuring surface roughness of a CMP pad, the device and method making it possible to achieve an accurate examination process by applying a micro shape measurement technology that can examine large-area polishing pads at a high speed at a CMP site.

Another object of the present disclosure is to provide a device and method for measuring surface roughness of a CMP pad, the device and method making it possible to efficiently measure and evaluate surface roughness of a polishing pad by applying common-path based phase modulation interferometry that is strong against external vibration and noise.

Another object of the present disclosure is to provide a device and method for measuring surface roughness of a CMP pad, the device and method making it possible to measure a surface profile even in an environment in which a pad is immersed in a slurry solution by using an interference phenomenon for profile measurement.

Another object of the present disclosure is to provide a device and method for measuring surface roughness of a CMP pad, the device and method making it possible to obtain interference images changing over time by finely vibrating an optical path of an interferometer reference arm (hundreds of nanometers) at a high speed, and then extract phase information from several interference images and restore 3D-profile information of a pad hidden in the phase information.

Another object of the present disclosure is to provide a device and method for measuring surface roughness of a CMP pad, the device and method making it possible to quickly perform pad surface profile measurement for a following polishing process by monitoring a profile in real time by making it possible to obtain pad profile information at a high speed by adjusting a light incident area to fit a measurement region.

Another object of the present disclosure is to provide a device and method for measuring surface roughness of a CMP pad, the device and method making it possible to maintain an optimal polishing condition and secure reproduction of polishing because it is possible to evaluate the lifespan of a pad and analyze and monitor an optimal replacement time and an optimal machining state of a wafer in real time at a CMP site.

Another object of the present disclosure is to provide a device and method for measuring surface roughness of a CMP pad, the device and method being able to improve the yield of ULSI semiconductor chips by making it possible to manufacture wafers having high-precision flatness by maintaining an optimal polishing condition and securing reproduction of polishing.

The objects of the present disclosure are not limited to those described above and other objects may be made apparent to those skilled in the art from the claims.

A device for measuring surface roughness of a CMP pad according to embodiments of the present disclosure includes: a light radiator having a light source; a light flux divider configured to divide and radiate light emitted from the light radiator to a measurement target; an interference image creator configured to generate interference by overlapping reflective light of the measurement target, which is generated when light is radiated to the measurement target through the light flux divider, and the light radiated to the measurement target; an image obtaining-storing unit configured to obtain several interference pattern-modulated images created by the interference image creator; and an image post-processing output unit configured to output a 3D pad surface profile by performing post-processing on the interference pattern-modulated images of the image obtaining-storing unit.

The light radiator may have an LED light source having a small spectrum FWHM (Full Width at Half Maximum).

The interference image creator may modulate an interference pattern by changing an optical path difference by generating up-down fine vibration using a piezoelectric element (PZT).

Interference images that change over time may be obtained by finely vibrating an optical path of an interferometry reference arm at a high speed using the piezoelectric element, and then 3D profile information of a pad in phase information may be restored using the interference images.

The interference image creator is made of a light transparent glass or transparent film that functions as a reference arm reflector and is positioned over the measurement target, incident light is reflected by a bottom of the glass and a surface of the measurement target, and two beams of light overlap each other, whereby interference may be generated.

Since the overlapping beams of light share the same optical path, reference light and sample light undergo the same optical path variation due to external noise and vibration, and accordingly, the optical path difference becomes 0. Accordingly, an initial interference signal may be intactly maintained, so a 2D interference image that is very dull to external vibration may be recorded in the image obtaining-storing unit.

The piezoelectric element (PZT) and a CCD camera constituting the image obtaining-storing unit may be simultaneously triggered to synchronize a motion of the piezoelectric element (PZT) and an image reception timing of the image obtaining-storing unit.

The image post-processing output unit may output a final 3D pad surface profile by performing post-processing processes of optical phase extraction, a phase unfolding process, and phase gradient correction.

A profile may be monitored in real time by obtaining profile information of the measurement target at a high speed by adjusting a light incident area to fit a measurement region of the interference image creator in which the measurement target is positioned.

In order to achieve another object, a method of measuring surface roughness of a CMP pad according to the present disclosure includes: radiating light from an LED light source to a measurement target through a light flux divided and an objective lens; generating interference by overlapping reflective light of an interference image creator and reflective light of the measurement target; modulating an interference pattern by changing an optical path difference by generating up-down fine vibration using a piezoelectric element (PZT) by means of the interference image creator; and outputting a final 3D pad surface profile by performing post-processing processes of optical phase extraction, a phase unfolding process, and phase gradient correction after obtaining several interference pattern-modulated images by means of an image obtainer.

The device and method for measuring surface roughness of a CMP pad according to the present disclosure described above have the following effects.

First, it is possible to efficiently evaluate surface roughness of a polishing pad through non-contact nondestructive optical measurement at a site where CMP (Chemical Mechanical Polishing) that is a necessary process for planarizing silicon wafers is performed.

Second, it is possible to achieve an accurate examination process by applying a micro shape measurement technology that can examine large-area polishing pads at a high speed at a CMP site.

Third, it is possible to efficiently measure and evaluate surface roughness of a polishing pad by applying common-path based phase modulation interferometry that is strong against external vibration and noise.

Further, it is possible to measure a surface profile even in an environment in which a pad is immersed in a slurry solution by using an interference phenomenon for profile measurement.

Fifth, it is possible to obtain interference images, which change over time, by finely vibrating the optical path of an interferometer reference arm (hundreds of nanometers) at a high speed, and then it is possible to restore 3D profile information of a pad hidden in phase information using the interference images.

Sixth, it is possible to quickly perform pad surface profile measurement for a following polishing process by monitoring a profile in real time by making it possible to obtain pad profile information at a high speed by adjusting a light incident area to fit a measurement region. Seventh, it is possible to maintain an optimal polishing condition and secure reproduction of polishing because it is possible to evaluate the lifespan of a pad and analyze and monitor an optimal replacement time and an optimal machining state of a wafer in real time at a CMP site.

Eighth, it is possible to improve the yield of ULSI semiconductor chips by making it possible to manufacture wafers having high-precision flatness by maintaining an optimal polishing condition and securing reproduction of polishing.

### BRIEF DESCRIPTION OF THE DRAWINGS

FIG. 1 is a block diagram showing the configuration of a device for measuring surface roughness of a CMP pad according to the present disclosure.

FIG. 2 is a detailed block diagram showing the configuration of the device for measuring surface roughness of a CMP pad according to the present disclosure.

FIG. 3 is a flowchart showing a method of measuring surface roughness of a CMP pad according to the present disclosure.

FIG. 4 is a diagram showing a final polishing pad surface profile obtained using the device for measuring surface roughness of a CMP pad according to the present disclosure.

### DETAILED DESCRIPTION

A device and method for measuring surface roughness of a CMP pad according to the present disclosure according to embodiments of the present disclosure are described in detail with reference to the accompanying drawings. The present disclosure may be modified in various ways and implemented by various exemplary embodiments, so that specific exemplary embodiments are shown in the drawings and will be described in detail herein. However, it is to be understood that the present disclosure is not limited to the specific exemplary embodiments, but includes all modifications, equivalents, and substitutions included in the spirit and the scope of the present disclosure. Similar reference numerals are assigned to similar components in the following description of drawings. The dimensions of the structures in the accompanying drawings are exaggerated in comparison to the actual dimensions to make the present disclosure clear or are reduced in comparison to the actual dimensions for schematic understanding of the configuration.

Terms used in the specification, “first”, “second”, etc., may be used to describe various components, but the components are not to be construed as being limited to the terms. The terms are used only to distinguish one component from another component. For example, the “first” component may be named the “second” component, and vice versa, without departing from the scope of the present disclosure.

Unless defined otherwise, it is to be understood that all the terms used in the specification including technical and scientific terms have the same meaning as those that are understood by those who are skilled in the art. It will be further understood that terms such as terms defined in common dictionaries should be interpreted as having a meaning that is consistent with their meaning in the context of this specification and the relevant art and will not be interpreted in an idealized or overly formal sense unless expressly so defined herein.

FIG. 1 is a block diagram showing the configuration of a device for measuring surface roughness of a CMP pad according to the present disclosure.

The device and method for measuring surface roughness of a CMP pad according to the present disclosure make it possible to efficiently evaluate surface roughness of a polishing pad through non-contact nondestructive optical measurement at a site where CMP that is a necessary process for planarizing silicon wafers is performed.

To this end, the present disclosure may include a configuration that achieves an accurate examination process by applying a micro shape measurement technology that can examine large-area polishing pads at a high speed at a CMP site and measures and evaluates surface roughness of a polishing pad by applying a common-path based phase modulation interferometry that is strong against external vibration and noise.

The present disclosure may include a configuration that can measure a surface profile even in an environment in which a pad is immersed in a slurry solution by using an interference phenomenon for profile measurement, and obtains interference images changing over time by finely vibrating an optical path of an interferometer reference arm (hundreds of nanometers) at a high speed, and then restores 3D-profile information of a pad hidden in the phase information using the interference images.

The present disclosure may include a configuration that monitors a profile in real time by making it possible to obtain pad profile information at a high speed by adjusting a light incident area to fit a measurement region.

Three requirements that measurement equipment should have to examine a CMP pad at a site are (1) being dull to external vibration when measuring, (2) easy access to a pad in a slurry suspension, and (3) making a following polishing process smooth by quickly measure the surface profile of a pad.

The present disclosure employs common-path based phase modulation interferometry to satisfy these requirements.

A device for measuring surface roughness of a CMP pad according to the present disclosure, as shown in FIG. 1, includes: a light radiator 11 composed of an LED light source, a filter, a lens, an aperture stop, a field stop, and a lens to configure a common-path based phase modulation interferometer for measuring surface roughness of a CMP pad, and radiating light; a light flux divider 12 dividing and radiating the light from the LED light source to a measurement target 14 or sending reflective light dispersed from a sample to an image obtaining-storing unit 15; an interference image creator 13 generating interference by overlapping reflective light of the interference image creator 13 and the measurement target when light is radiated to the measurement target 14 through the light flux divider 12 and an objective lens, and modulating an interference pattern by changing an optical path difference by generating fine vibration up and down using a piezoelectric element (PZT); the image obtaining-storing unit 15 obtaining several interference pattern-modulated images created by the interference image creator 13; and an image post-processing output unit 16 outputting a final 3D pad surface profile through post-processing processes of optical phase extraction, a phase unfolding process, phase gradient correction.

The device for measuring surface roughness of a CMP pad according to the present disclosure makes it possible to obtain pad profile information at a high speed by adjusting a light incident area to fit a measurement region.

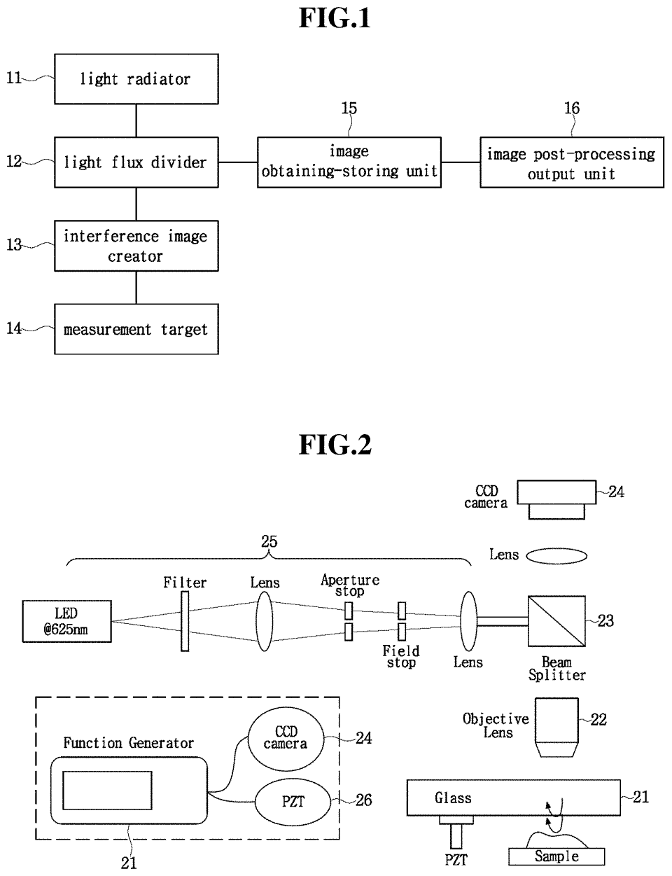

FIG. 2 is a detailed block diagram showing the configuration of the device for measuring surface roughness of a CMP pad according to the present disclosure.

The device for measuring surface roughness of a CMP pad according to the present disclosure, as shown in FIG. 2, includes: an interference image creator 21 to which a piezoelectric element (PZT) 26 generating optical path difference variation using up-down fine vibration is attached and that is made of flat glass or a transparent film under which a measurement target is positioned; an objective lens 22 that adjusts a light incident area to fit a measurement region; a light flux divider 23 that divides and radiates light from the LED light source to a measurement target; an image obtaining-storing unit 24 that obtains several interference pattern-modulated images created by the interference image creator 21; and a light radiator 25 that radiates a light source.

The device for measuring surface roughness of a CMP pad according to the present disclosure is based on a common-path interferometer, in which a light transparent glass or transparent film that functions as a reference arm reflector is positioned over a sample, light from the LED light source can be reflected by the bottom of the glass and the surface of the sample (pad) through the objective lens 22 from the light flux divider 23, and in this case, two beams of light overlap each other, whereby interference is generated.

Since the overlapping beams of light share the same optical path, reference light and sample light undergo the same optical path variation due to external noise and vibration, and accordingly, the optical path difference becomes 0. Accordingly, an initial interference signal can be intactly maintained, so a 2D interference image that is very dull to external vibration is recorded in a high-speed CCD that is the image obtaining-storing unit 24.

In order to measure the surface of a pad immersed in a slurry or a wet pad, the objective lens 22 is replaced with a water immersion objective lens, the gap between the glass and the objective lens is filled with water drops, and the bottom of the glass and the surface of the sample are positioned within a coherence length, whereby interference can be generated on the surface of the pad in the slurry.

When the transparent glass is finely vibrated up and down using the piezoelectric element (PZT) 26 attached to the transparent glass of the interference image creator 21, the optical path difference between the glass and the sample surface changes, so an interference pattern is moved on the CCD image. Further, several interference pattern-modulated images are obtained by recording interference images, which are modulated over time, on the CCD and then post-processing processes (optical phase extraction, a phase unfolding process, and phase gradient correction) are performed, whereby a final 3D pad surface profile can be obtained.

In order to measure the surface of a pad at a real site, an optical system should be strong against environmental noise and is required to be able to perform image work in the state with a lot of water due to slurry of the pad and is required to be simply configured.

FIG. 2 shows a sample and a device for measuring surface roughness of a CMP pad which has common optical path of a reference arm.

Since two arms have the same path, it is advantageous in terms of duration against vibration or simplicity of a system.

Characteristics of the device for measuring surface roughness of a CMP pad according to the present disclosure and another profile measurement equipment are compared in the following

TABLE 1

| Comparison of another | | | | | |
|---|---|---|---|---|---|
| profile measurement | | High-speed | | Large-area | |
| equipment and the | | profile | | profile | In-situ |
| proposed technology | Non-contact | measurement | | measurement | measurement |
| Stylus profiler | X | X | (minutes) | X | X |
| Scanning Electron | X | X | (hours) | X | X |
| Microscopy(SEM) | | | | | |
| Atomic Force | ◯ | X | (minutes) | X | X |
| Microscopy | | | | | |
| Optical Microscopy | ◯ | ◯ | (few seconds) | X | X |
| Confocal Microscopy | ◯ | ◯ | (few seconds) | X | Possible |
| Proposed Method | ◯ | ◯ | (real-time) | ◯ | ◯ |

A PZT and a CCD camera are simultaneously triggered to synchronize a PZT motion and the image reception timing of the CCD camera.

Since the present disclosure fundamentally includes the common-path optical interferometer, there is the advantage that a generated interference signal is very dull to external vibration and noise unlike a Michelson interferometer-based profile measurement technique having an independent double-arm structure.

Further, since a physical phenomenon called interference is used to measure a profile, interference can be generated even in an extreme situation in which a pad is immersed in a slurry solution as long as the surface of the pad is positioned within a coherence gate at which interference can be generated, so it is possible to measure a surface profile.

It is possible to obtain interference images, which change over time, by finely vibrating the optical path of an interferometer reference arm (hundreds of nanometers) at a high speed, and then it is possible to restore 3D profile information of a pad hidden in phase information using the interference images.

The restoration speed theoretically depends on an array detector (e.g., a CCD camera) and a computing speed. If the speed of the array detector is 200 Hz, it is possible to monitor a profile in real time at a profile restoration speed of 5 ms (interference image obtaining speed)+αms (computing time) or less.

In particular, since it is possible to adjust a light incident area to fit a measurement region in accordance with the magnification of an objective lens, it is possible to obtain the information of a pad profile over tens of centimeters at a high speed even though the lateral resolution slightly decreases.

A coherence gate l [symbol] that determines axial resolution and shows an available measurement image range in the device for measuring surface roughness of a CMP pad according to the present disclosure can be obtained as in the following Equation 1.

$$\text{?} = \frac{2 ln 2}{π} \cdot \frac{{( {λ}_{0} )}^{2}}{Δλ} \\ \text{?} \text{indicates text missing or illegible when filed} \qquad [ Formula 1 ]$$

where λ [symbol] is a central wavelength and Δλ is a spectrum FWHM (Full Width at Half Maximum) of a light source.

In an embodiment of the present disclosure, since a light source of a 632.8 nm central wavelength and a 1.3 nm spectrum FWHM after passing through a filter is used, the coherence gate is about 136 μm.

In the present disclosure, accumulation images E₁(x,y), E₂(x,y), E₃(x,y), and E₄(x,y) are received and stored using a LabVIEW program developed for one sine wave cycle of a PZT.

In a fourth buckets method, the phase [symbol] at each point can be calculated through Equation 2 when an average phase error for a phase value is 0.

$$ϕ ( x , y ) = {tan}^{- 1} ( \frac{{E}_{1} - {E}_{2} - {E}_{3} + {E}_{4}}{{E}_{1} - {E}_{2} + {E}_{3} - {E}_{4}} \text{?} \\ \text{?} \text{indicates text missing or illegible when filed} \qquad [ Formula 2 ]$$

A method of measuring surface roughness of a CMP pad according to the present disclosure is described in detail hereafter.

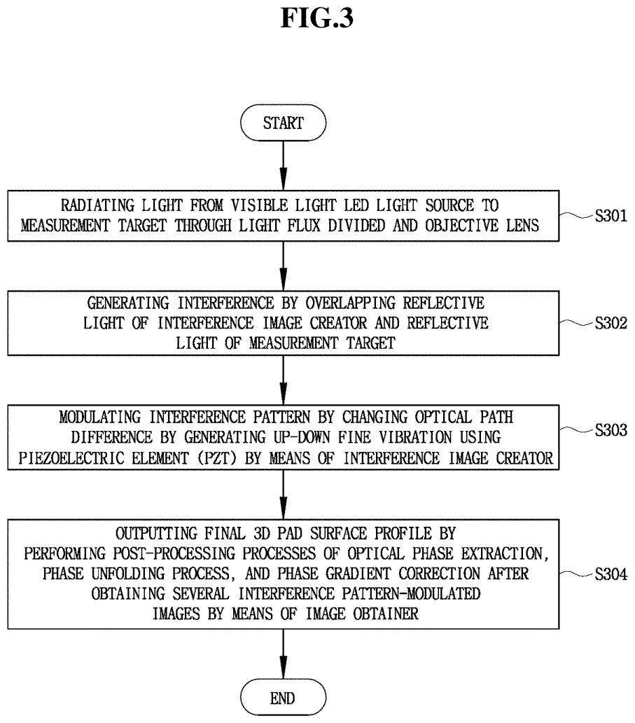

FIG. 3 is a flowchart showing a method of measuring surface roughness of a CMP pad according to the present disclosure.

First, the light from the LED light source is radiated to a measurement target through the light flux divided and the objective lens (S301).

Next, interference is generated by overlapping the reflective light of the interference image creator and the reflective light of the measurement target (S302).

Further, the interference image creator modulates an interference pattern by changing an optical path difference by generating up-down fine vibration using the piezoelectric element PZT (S303).

Next, the image obtainer obtains several interference pattern-modulated images and then post-processing processes of optical phase extraction, a phase unfolding process, and phase gradient correction are performed, whereby a final 3D pad surface profile is output (S304).

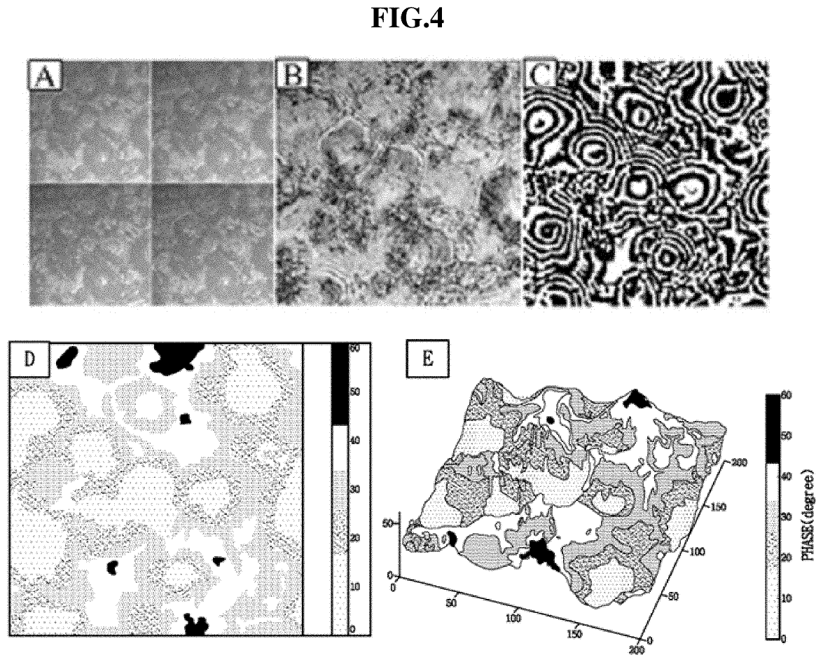

FIG. 4 is a diagram showing a final polishing pad surface profile obtained using the device for measuring surface roughness of a CMP pad according to the present disclosure.

In FIG. 4, (A) shows four CCD images obtained by modulating an interference pattern, which was generated on the surface of a polishing pad immersed in water, over time, (B) is a reflection intensity image of the polishing pad obtained from the four images, (C) is an optical phase difference image with a phase folded before image post-processing is performed on the polishing pad, and (D) is an optical phase difference distribution image of the polishing pad obtained after image post-processing.

Further, (E) shows the information of (D) in a 3D profile distribution profile of the polishing pad, that is, shows a porous surface that is a typical characteristic of a polishing pad.

The device and method for measuring surface roughness of a CMP pad according to the present disclosure described above make it possible to efficiently evaluate surface roughness of a polishing pad through non-contact nondestructive optical measurement at a site where CMP that is a necessary process for planarizing silicon wafers is performed.

The common-path interferometry used in the present disclosure may be similar to Mirau interferometry that is generally used for surface profile measurement. However, according to Mirau interferometry, a special interferometer objective lens having a reference arm mirror and a light flux divider therein is used. Further, if the interferometer objective lens is immersed into slurry to measure the profile of a CMP pad, an optical path difference is unavoidably generated due to a different refractive index between the reference arm in the objective lens and the surrounding of the sample. Further, when the difference is larger than the coherence length, interference may not be generated. Further, when the reference arm mirror is made of metal, the reflectivity of the mirror is very larger than the reflectivity of the pad, so the contrast of an interference signal may be considerably decreased even if interference is generated.

However, since the present disclosure employs a water immersion lens, a reference arm mirror, and a flat glass that functions as a light flux divider, which are separate parts, it is possible to minimize a refractive index difference between the reference arm and the surrounding of a sample. Further, since it is possible to move up and down the position of the glass, it is possible to generate an interference signal by positioning the glass within the coherence length. Further, since the reflectivity of the glass is similar to the reflectivity of a pad, it is possible to maintain high interference signal contrast.

In this way, the present disclosure provides an effective solution for the problems with examination of a polishing pad at a site which remains as a difficult subject for a long time in the wafer processing field, thereby making it possible to evaluate the lifespan of a pad, and analyze and monitor an optimal replacement time and a real-time optimal machining state of a wafer at a CMP site.

Accordingly, since an optical polishing condition is maintained and reproduction of polishing is secured, it is possible to produce wafers having high-precision flatness, whereby it is possible to improve the yield of ULSI semiconductor chips.

Although exemplary embodiments of the present disclosure were described above, it should be understood that the present disclosure may be changed and modified in various ways by those skilled in the art without departing from the spirit and scope of the present disclosure described in the following claims.

What is claimed is:

1. A device for measuring surface roughness of a CMP pad, the device comprising:
a light radiator having a light source;
a light flux divider configured to divide and radiate light emitted from the light radiator to a measurement target;
an interference image creator configured to generate interference by overlapping reflective light of the measurement target, which is generated when light is radiated to the measurement target through the light flux divider, and the light radiated to the measurement target;
an image obtaining-storing unit configured to obtain several interference pattern-modulated images created by the interference image creator; and
an image post-processing output unit configured to output a 3D pad surface profile by performing post-processing on the interference pattern-modulated images of the image obtaining-storing unit.

2. The device of claim 1, wherein the light radiator has an LED light source having a small spectrum FWHM (Full Width at Half Maximum).

3. The device of claim 1, wherein the interference image creator modulates an interference pattern by changing an optical path difference by generating up-down fine vibration using a piezoelectric element (PZT).

4. The device of claim 3, wherein interference images that change over time are obtained by finely vibrating an optical path of an interferometry reference arm at a high speed using the piezoelectric element, and then 3D profile information of a pad in phase information is restored using the interference images.

5. The device of claim 3, wherein the interference image creator is made of a light transparent glass or transparent film that functions as a reference arm reflector and is positioned over the measurement target, incident light is reflected by a bottom of the glass and a surface of the measurement target, and two beams of light overlap each other, whereby interference is generated.

6. The device of claim 5, wherein the overlapping beams of light are not influenced by external noise and vibration by sharing the same optical path, and a 2D interference image is stored in the image obtaining-storing unit.

7. The device of claim 3, wherein the piezoelectric element (PZT) and a CCD camera constituting the image obtaining-storing unit are simultaneously triggered to synchronize a motion of the piezoelectric element (PZT) and an image reception timing of the image obtaining-storing unit.

8. The device of claim 1, wherein the image post-processing output unit outputs a final 3D pad surface profile by performing post-processing processes of optical phase extraction, a phase unfolding process, and phase gradient correction.

9. The device of claim 1, wherein a profile is monitored in real time by obtaining profile information of the measurement target at a high speed by adjusting a light incident area to fit a measurement region of the interference image creator in which the measurement target is positioned.

10. A method of measuring surface roughness of a CMP pad, the method comprising:
radiating light from an LED light source to a measurement target through a light flux divided and an objective lens;
generating interference by overlapping reflective light of an interference image creator and reflective light of the measurement target;
modulating an interference pattern by changing an optical path difference by generating up-down fine vibration using a piezoelectric element (PZT) by means of the interference image creator; and
outputting a final 3D pad surface profile by performing post-processing processes of optical phase extraction, a phase unfolding process, and phase gradient correction after obtaining several interference pattern-modulated images by means of an image obtainer.

11. The method of claim 10, wherein a coherence gate l [symbol] that determines axial resolution and shows an available measurement image range is obtained through
$$\text{?} = \frac{2 ln 2}{π} \cdot \text{?}$$
$$\text{?} \text{indicates text missing or illegible when filed}$$
in order to measure surface roughness of a CMP pad that is the measurement target,
where λ [symbol] is a central wavelength and Δμ is a spectrum width of a light source.
